(19) United States
(12) Patent Application Publication
(10) Pub. No.: US 2022/0396070 A1
(43) Pub. Date: Dec. 15, 2022

(54) INPUT VOLTAGE AGNOSTIC FLUIDIC DEVICES WITH CLAMP CIRCUITS

(71) Applicant: Hewlett-Packard Development Company, L.P., Spring, TX (US)

(72) Inventors: Eric T. Martin, Corvallis, OR (US); Berkeley Fisher, Corvallis, OR (US)

(73) Assignee: Hewlett-Packard Development Company, L.P., Spring, TX (US)

(21) Appl. No.: 17/772,773

(22) PCT Filed: Nov. 20, 2019
(86) PCT No.: PCT/US2019/062351

§ 371 Date: Apr. 28, 2022

(51) Int. Cl. B41J 2/045

(52) U.S. Cl. CPC B41J 2/04541

(57) ABSTRACT

An example input voltage agnostic fluidic device may include a level shifter to adjust an input voltage of control signals received at an input interconnect to a voltage level that is within operational thresholds of on-chip devices of the input voltage agnostic fluidic device. A clamp circuit may be provided to clamp circuitry downstream of the level shifter below the operational threshold of the on-chip device.

### BACKGROUND

Fluidic devices are devices through which fluids and/or electric signals may propagate. Fluidic devices may be used by printing devices, such as to eject fluids on a print media. Fluidic devices may also be used for bio-medical devices, such as to perform tests on fluids. Based on electric signals received, fluidic devices may cause propagation of fluids through microchannels of the fluidic devices. The voltage levels corresponding to the electric signals may depend on the particular fabrication processes used to manufacture the fluidic devices.

### BRIEF DESCRIPTION OF THE DRAWINGS

Various examples will be described below by referring to the following figures.

FIG. 1 is a schematic illustration of an example fluidic device;

FIGS. 2A-2C illustrate an example fluid ejection system having a fluidic device;

FIG. 3 is a schematic illustration of an example bio-medical devices having a fluidic device;

FIG. 4 is a schematic illustration of an example voltage level shifter;

FIGS. 5A-5E illustrate different voltage divider implementations;

FIG. 6 illustrates an example fluidic die;

FIG. 7 is a schematic illustration of aspects of an example fluidic device;

FIG. 8 is a flow diagram of an example method of adjusting a voltage level of a control signal;

FIG. 9 is flow diagram of an example method of forming a fluidic device;

FIGS. 10A-E illustrate different clamp circuit implementations; and

FIG. 11 is a flow diagram of an example method of adjusting a voltage level of a control signal using a level shifter and clamping a voltage downstream of the level shifter.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration.

### DETAILED DESCRIPTION

References throughout this specification to one implementation, an implementation, one example, an example, and/or the like means that a particular feature, structure, characteristic, and/or the like described in relation to a particular implementation and/or example is included in at least one implementation and/or example of claimed subject matter. Thus, appearances of such phrases, for example, in various places throughout this specification are not necessarily intended to refer to the same implementation and/or example or to any one particular implementation and/or example. Furthermore, it is to be understood that particular features, structures, characteristics, and/or the like described are capable of being combined in various ways in one or more implementations and/or examples and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers to the context of the present disclosure.

At times, input voltage tolerances for fluidic devices, such as fluid ejection devices (e.g., an inkjet printhead) are narrow and/or inflexible. There may be a desire to work around this lack of flexibility to enable use of fluidic devices in systems for which they were not designed, by way of example. This is illustrated in a non-limiting manner by the following example fluidic device.

One example fluidic device may be fabricated using a first process. For instance, fluidic dies of one thermal inkjet (TIJ) product may be manufactured using a 4 μm photolithographic process. Due, in part, to this process, the resulting fluidic dies may call for relatively high node voltages (e.g., 10V-20V) applied to on-chip devices (e.g., transistor gates) to operate. These dies will not operate properly if incorrect voltages are applied, such as less than 10V and/or greater than 20V.

Continuing with this example, TIJ dies manufactured with a different process, such as a 1 μm process, may have different operational parameters (e.g., approximately 5V applied to transistor gates for 1 μm process) as contrasted with those of the 4 μm process. As a result, 1 μm process-produced dies may not be usable in a system designed for 4 μm dies, and vice versa. More generally, then, it may not be possible to use fluidic devices of a second process (e.g., a 1 μm process) with a system designed for fluidic devices of a first (different) process (e.g., a 4 μm process), and vice versa, without making changes to the system and/or the fluidic devices.

Altering the system to use fluidic devices not designed for the system may not be practicable in some cases. For instance, altering fluidic device systems that are installed and in use may be costly, complex, and/or inconvenient. For instance, if many systems are deployed, it may not be feasible to replace or alter the systems to use fluidic devices of another type.

Conversely, altering fluidic devices to function in a non-matching system (e.g., a system not designed for a particular fluidic device process) may be costly. For instance, R&D investment to design, test, and manufacture a new backwards compatible fluidic device may be not commensurate with a possible eventual revenue on that investment.

There may be a desire, therefore, for an approach that overcomes the inflexibility of the fluidic device (e.g., allowing a fluidic device of a particular process to be used in a system outside of operating parameters).

In view of the foregoing, the present description proposes an input voltage agnostic fluidic device. A voltage lever shifter is to be included in the fluidic device to shift an input voltage to a level that is within operational thresholds of on-chip devices, such as the voltages applied at transistor gates. Also provided herein are examples in which various clamp circuits are coupled with level shifters described herein in order to protect against excessive voltages that may be within operational thresholds of level shifters described herein but not to downstream components such as on-chip devices described herein.

As used herein, the term “agnostic” is used to mean that the fluidic device is designed to work in systems that have not been adapted for the fluidic device. Input voltage agnostic fluidic devices are thus designed to operate in systems that use control signals having input voltages that differ from those corresponding to the particular process of the fluidic devices. By way of example, an example input voltage agnostic fluidic device may have been formed using a process corresponding to 5V signals but may nevertheless be capable of functioning in a system with signals on the order of 10V-20V (e.g., without damaging the on-chip components). And as shall be discussed in greater detail hereinafter, in some implementations, example input voltage agnostic fluidic devices may be configurable to enable operation in a number of different systems (e.g., 10V, 12V, 16V, etc.).

As used herein, the term “level shifter” refers to physical structure (e.g., circuit components, such as transistors, diodes, resistors, capacitors, inductors, and the like) that is capable of shifting an input voltage level from one range to another. For instance, in one example case, the level shifter may shift an input voltage from a first voltage range (e.g., 0-10V) to a second voltage range (e.g., 0-5V). Level shifters may be capable of shifting input voltage in any direction (e.g., up or down). Different level shifter implementations will be described in further detail hereinafter.

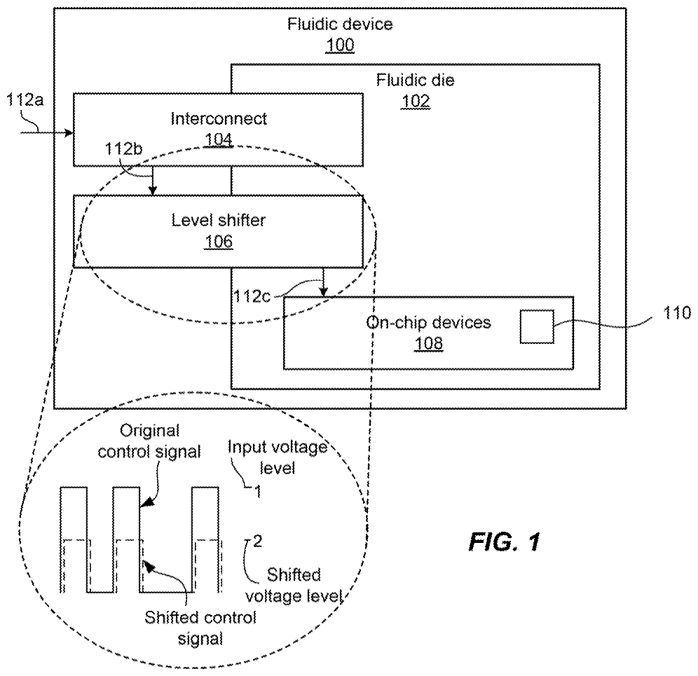

FIG. 1 illustrates a fluidic device 100 having a number of components. Fluidic device 100 includes, for instance, fluidic die 102 (which, in turn, includes on-chip devices 108), a level shifter 106, and an electrical interconnect component 104 (also referred to as an “interconnect” or “electrical interconnect”). Level shifter 106 and interconnect 104 are illustrated as being partly on fluidic die 102. This is intended to illustrate that in one implementation, level shifter 106 and/or interconnect 104 may be arranged in part off of fluidic die 102. However, in other cases, level shifter 106 and/or interconnect 104 may be entirely arranged on fluidic die 102, without limitation.

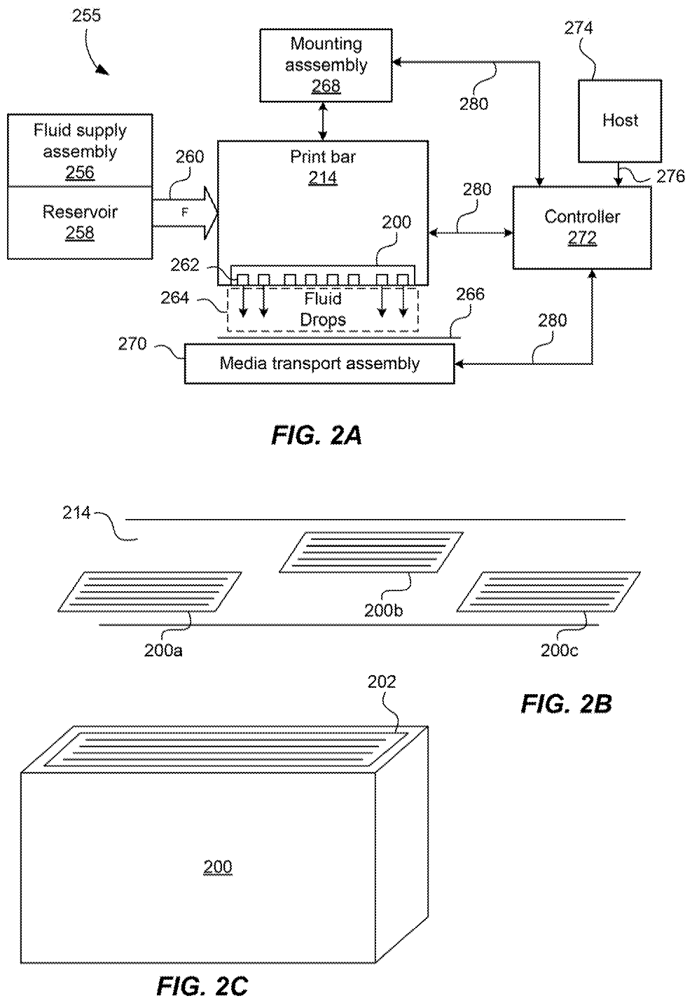

Fluidic device 100 refers to a combination of hardware and/or software and firmware (but not software per se) through which fluids and/or electric signals may propagate. The electric signals may include control signals, such as in the form of pulse width modulated signals. The fluids may comprise marking fluids, such as inks, and biological fluids, such as blood, by way of example. In one example case, fluidic device 100 may represent a print module of a printing device capable of delivering printing fluids to ejection chambers for ejection onto a substrate or build material (see FIGS. 2A-2C and supporting description for further details). In this case, fluidic device 100 may comprise a replaceable printhead module, for example. For instance, a print bar of the printing device may include a number of fluidic devices 100, which may operate in concert in order to form objects, text, and/or images on a target material.

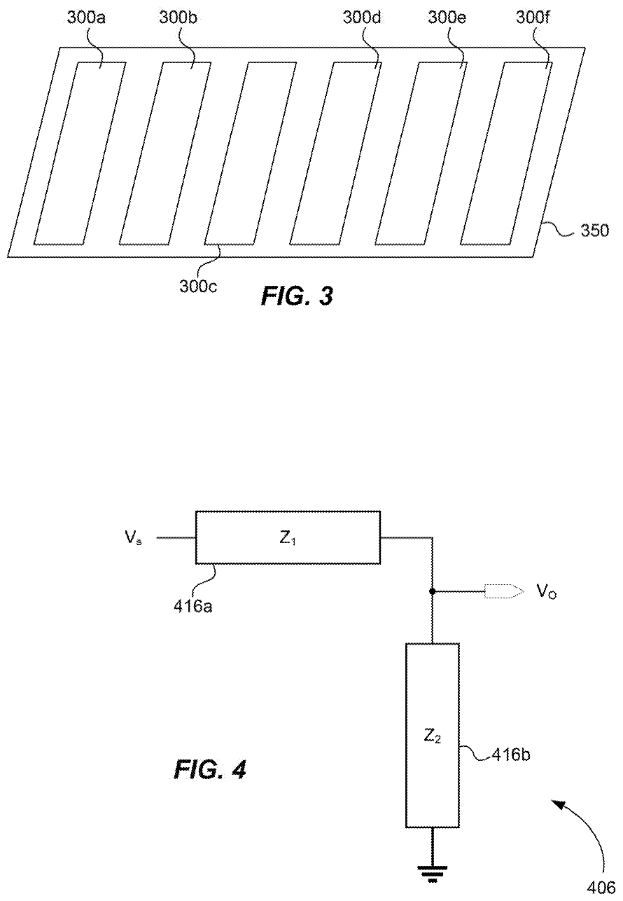

In another implementation, fluidic device 100 may refer to a component to be used for diagnostic tests on biological fluids (see FIG. 3 and supporting description for further details), For instance, fluidic device 100 may comprise a diagnostic test device into which fluids, such as blood, may be introduced for testing. In this case, fluidic device 100 may refer to a replaceable component, such as after each test, such to enable successive tests with reduced amounts of waste and/or cost.

Fluidic die 102 refers to a die in the context of integrated circuits, which includes a number of structural features and components to form functional circuitry and fluidic elements. For instance, in one implementation, a substrate such as silicon may be used as a base upon which structural features, such as integrated circuit elements (e.g., resistors, capacitors, transistors, etc.) may be formed through processes such as photolithographic processes and other like build-up or machining processes. Fluidic die 102 includes a number of fluidic channels and wire traces, which are used for the propagation of fluids and electric signals, respectively. The fluidic channels and wire traces may also be formed through processes such as photolithographic process and other like build-up or machining processes.

As noted, fluidic die 102 may include structural features, such as on-chip devices 108. On-chip devices 108 refers to circuit components, such as resistors, capacitors, and transistors. On-chip devices 108 may have a number of operational parameters and thresholds, such as based upon the process by which they were manufactured. The device fabrication process may dictate operating voltages of resulting on-chip devices 108. As such, for a device made using a 10 μm process, node voltage level for operation of on-chip devices will be different than that of a device made using a 1 μm process. As noted, for a number of reasons, there is a desire for an approach that will allow devices having a first set of operational parameters and thresholds to be replaced by a device having a second (different) set of operating parameters and thresholds. Operational parameters and thresholds, such as operating voltages of on-chip devices 108, are referred to by block 110 and include transistor saturation levels and threshold voltages, capacitance of levels of semiconductor layers, physical dimensions of portions of the transistor, etc.

Moving on, interconnect 104 refers to an electrically conductive component (e.g., metallic, metalloid, conductive non-metals, etc.) through which control signals are to be received for transmission on to on-chip devices 108. In some cases, fluidic device 100 may include a first interconnect 104, and control signals may be received and sent on to a second interconnect (not depicted) arranged on fluidic die 102. For instance, interconnect 104 may be off of fluidic die 102, but may be connected through a direct or indirect connection to a wire trace of fluidic die 102.

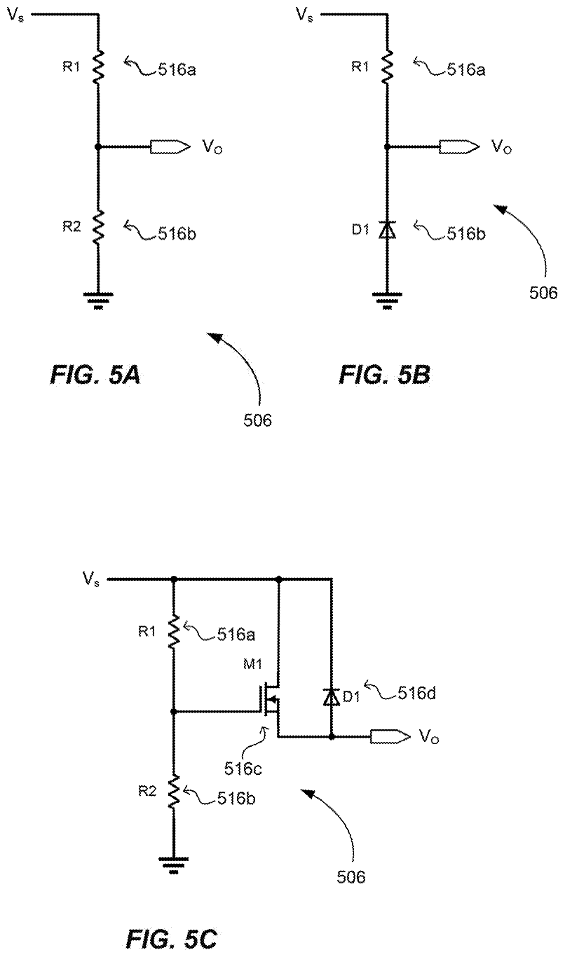

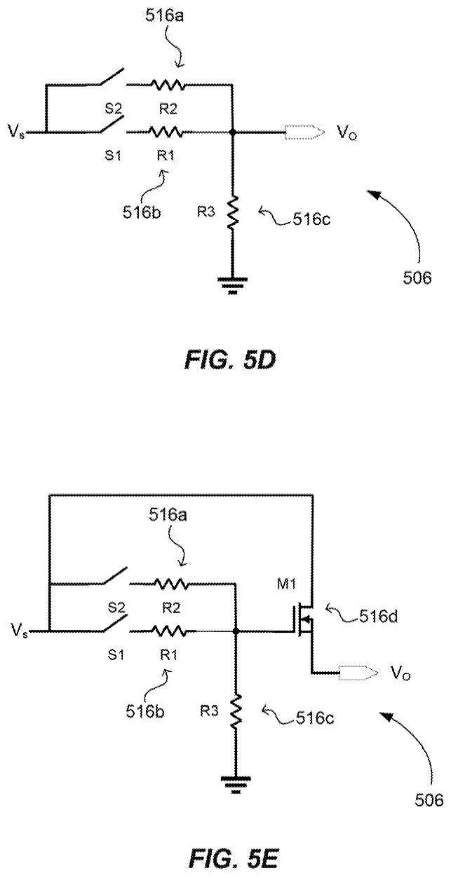

Level shifter 106 is arranged between interconnect 104 and on-chip devices 108. As noted, above, level shifter 106 refers to structure that yields a shift in voltage levels from a voltage level received at interconnect 104 to a shifted voltage level that is to be sent on to on-chip devices 108 (see FIGS. 4-5E and supporting description for further details).

The broken ovals in FIG. 1 are to draw the reader's attention to the operation of level shifter 106 with reference to control signals received via interconnect 104. For instance, control signals may be received by fluidic device 100 from a source external to fluidic device 100, as represented by arrow 112a. In one case, the control signals may be sent by a processing component, such as a controller. The control signals may be passed on to level shifter 106, as represented by arrow 112b. And level shifter 106 may pass on a shifted version of the control signals, as represented by arrow 112c. The sample signal pulse illustration in the lower oval illustrates an example control signal (solid line) with an initial voltage level, indicated as a first voltage level or input voltage level (and which corresponds to the control signals at arrows 112a and 112b). The step function-like illustration also shows a downward shifting of the control signals to yield a shifted control signal (dotted line) corresponding to a second voltage level, represented by the shifted voltage level (which corresponds to the control signals at arrow 112c). It is noted that the dotted line of the shifted control signal is slightly to the right on the x-axis. This is done to clearly illustrate the difference between the original and shifted control signals and not, necessarily, to illustrate delay (though, in some cases, level shifter 106 may introduce delays into the system).

At times, the present description may refer to “shifting” an input voltage from an original or first level to a shifted or second level. This terminology is used to simplify the present description and is intended to encompass the shifting of control signal levels, such as illustrated in FIG. 1. Additionally, it is noted that to simplify description, shifting voltage “levels” is used to refer to shifting an entire voltage range (e.g., up or down) or to refer to shifting an upper and/or lower threshold of a voltage range.

Also, the use of a simple signal line to represent voltage levels is done without limitation. For instance, in an example in which pulse-width modulated (PWM) signals are used to engender operation (e.g., ejection of marking fluids, actuation of micropumps, etc.) of on-chip devices 108, the control signals may comprise high and low voltage values. In one case, level shifter 106 may reduce a high voltage value of the control signals (e.g., it may reduce voltage values of 16V, 12V, 10V, and the like). In cases in which a low voltage value of the control signals is approximately zero, level shifter 106 may not reduce the value of the control signals. Though in some cases, the low voltage value may also be reduced (e.g., in cases in which PWM signals are used to yield a sinusoidal waveform).

At times, the input voltage level and the shifted voltage levels may be expressed as a ratio. For instance, in a case in which an input voltage level of control signals is 10V and a shifted voltage level of control signals is 5V, the ratio of the shifted level to the original level may be approximately ½. In other cases, the ratio may be less than ½, such as between ¼ and ½, by way of example. As shall be shown, representing voltage levels in terms of a ratio may be useful for determining components to be used to form level shifter 106. Of course, in other implementations, rather than expressing shifted voltage as a ratio, voltage may be shifted by an absolute value (e.g., shifting by 5V, 10V, etc.). Different approaches for shifting input voltage, including the use of a voltage divider, will be described in greater detail hereinafter.

The foregoing will be described in the example context of a printing device implementation and a bio-medical implementation of input voltage agnostic fluidic devices and clamp circuits in the following paragraphs.

FIGS. 2A-2C illustrate an implementation of the fluidic device illustrated in FIG. 1 (fluidic device 100) in the context of a print device. It is noted that the fluidic devices illustrated in FIGS. 2A-2C may include components similar to those illustrated in and operate in a similar manner as the components of FIG. 1. For instance, like numbering (e.g., fluidic die 102 in FIG. 1 and fluidic die 202 in FIG. 2C) is used to indicate similar components, such as having similar structure and/or operation. Though, in some cases, differences may exist, and such difference may be apparent from context. Therefore, similar structure and/or operation of fluidic device 200 (and other components) are not repeated here.

FIG. 2A is a block diagram schematically illustrating an example fluid ejection system 255 (e.g., a printing device) including fluidic device 200. Fluid ejection system 255 comprises a print bar 214, which includes one or more fluidic devices 200 (one of which is shown), and a fluid supply assembly 256.

Fluid supply assembly 256 includes a fluid reservoir 258. From fluid reservoir 258, a fluid 260(F), such as ink, may be provided to print bar 214 to be fed to fluidic device 200. In an example, fluid supply assembly 256 is separate from print bar 214 and may supply fluid 260 to print bar 214 through a tubular connection, such as a supply tube (not shown). In other examples, print bar 214 may include fluid supply assembly 256, and fluid reservoir 258, along with fluidic device 200. In either example, fluid reservoir 258 of fluid supply assembly 256 may be removed and replaced or may be refilled.

From fluidic device 200, fluid 260 may be ejected from nozzles 262 as fluid droplets 264 towards a print medium 266, such as paper, Mylar, cardstock, and the like. Nozzles 262 of fluidic device 200 may be arranged in one or more columns or arrays to form characters, symbols, graphics, or other images to be formed on print medium 266 as print bar 214 and print medium 266 are moved relative to each other.

Fluid 260 is not limited to colored liquids used to form visible images on paper. For example, fluid 260 may be an electro-active substance used to print circuits and other items, such as solar cells. In some examples, the fluid 260 may include a magnetic ink. Additionally, fluid 260 may take the form of agents and colorless fluids, such as to provide a clear coat on print medium 266.

A mounting assembly 268 may be used to position the print bar 214 relative to the print medium 266. In an example, the mounting assembly 268 may be in a fixed position, holding a number of fluidic devices, such as fluidic device 200, above print medium 266. In another example, mounting assembly 268 may include a motor to move print bar 214 back and forth across print medium 266, A media transport assembly 270 may move print medium 266 relative to print bar 214, for example, moving print medium 266 perpendicular to print bar 214. In the example of FIG. 2A, media transport assembly 270 may include rollers as well as a number of motorized pinch rollers usable to pull print medium 266, such as in the form of a web, through printing system 255. If print bar 214 is moveable, media transport assembly 270 may index print medium 266 to new positions. In examples in which print bar 214 is not moveable, motion of print medium 266 may be continuous.

A controller 272 includes a combination of hardware and software/firmware processing to enable execution of instructions, such as instructions to eject print fluids. For instance, controller 272 may comprise a number of integrated circuits (ICs) that may be accessed by firmware (FW) and/or software (SW) in order to execute instructions. Examples of controller may include, for instance, field-programmable gate array (FPGAs), general purpose processing units, application-specific integrated circuits (ASICs), and the like, without limitation.

Controller 272 may receive data (e.g.; in the form of signals or states) from a host 274, such as a computer. The data may be transmitted over a network connection 276, which may comprise an electrical connection, an optical fiber connection, or a wireless connection, among others. Signals transmitted via network connection 276 may include a document or file to be printed, or may include more elemental items, such as a color plane of a document or a rasterized document. Controller 272 may temporarily store the signals in a local memory for analysis. The analysis may include determining timing control for the ejection of fluidic droplets from fluidic device 200, as well as motion of print medium 266 and/or motion of print bar 214. Controller 272 may operate individual components of printing system over control lines 280. Accordingly, controller 272 may define a pattern of fluid droplets 264 to be ejected and form characters, symbols, graphics, or other objects on print medium 266. For instance, controller 272 may transmit control signals having a first level to fluidic device 200. And a level shifter (e.g., level shifter 106 in FIG. 1) may shift the voltage level of the control signals to a different level.

FIG. 2B illustrates a number of fluidic devices 200a, 200b, and 200c (collectively referred to as fluidic device 200) arranged on a print bar 214, only a part of which is illustrated in FIG. 2B. In one example case, print media (e.g., print medium 266 in FIG. 2A) may be advanced under print bar 214 and printing fluid may be ejected from fluidic devices 200a, 200b, and 200c onto the media. Control signals may be sent to fluidic devices 200a, 200b, and 200c to cause ejection of the printing fluid, such as from a controller (e.g., controller 272 in FIG. 2A). The voltage level (e.g., a first voltage level) of the control signals may correspond to a fabrication process of a fluidic die (e.g., fluidic die 102 in FIG. 1) of fluidic devices 200a-200c, There may be a desire to replace fluidic devices 200a-200c with new fluidic devices that would need to receive control signals of a different voltage level (e.g., a second voltage level). FIG. 2C illustrates a fluidic device 200, such as may be used to replace the fluidic devices 200 of FIG. 2B. It is noted, however, that in other cases, rather than replacing individual fluidic devices 200a-200c, print bar 214 may be replaced in its entirety. Replacing fluidic devices 200 in FIG. 2B with fluidic devices having mismatched operational parameters and thresholds may be possible with a fluidic device like fluidic device 100 illustrated in FIG. 1. But before describing the mechanisms and processes to enable such device replacement, a bio-medical device example is presented hereinafter in reference to FIG.

FIG. 3 illustrates an implementation in which fluidic device 100 of FIG. 1 is used in a bio-medical context. For instance, bio-medical diagnostic device 350 may be a platform that may receive a number of fluidic devices 300a-300f (collectively, fluidic device 300), which may be used to manipulate biological fluids for testing purposes. The fluids may be received in reservoirs of fluidic devices 300 and analyzed and/or tested on fluidic dies of fluidic devices 300. For instance, the tests may be used to test for the presence of certain components of a fluid, such as the presence of a virus, bacteria, or a particular cell. Control signals may be transmitted, such as via bio-medical diagnostic device 350, to fluidic devices 300a-300f. Bio-medical diagnostic device 350 may be designed to use control signals having a first voltage level. However, there may be a desire to replace fluidic devices 300a-300f with new fluidic devices having different operational parameters (e.g., such as due to different fabrication processes). Therefore, replacement fluidic devices may also include structure similar to that illustrated in FIG. 1.

FIG. 4 illustrates an example level shifter 406 (e.g., similar to level shifter 106 of FIG. 1), In this implementation, a voltage divider is used to shift the input voltage levels (Vₛ) to a shifted voltage level (Vₒ). In this example, circuit components 416a and 416b represent a number of possible circuit components that, when arranged in series as illustrated in FIG. 4, may shift the voltage level of received control signals (e.g., input voltage) to a shifted voltage level. In one example, for instance, circuit components 416a and 416b may be resistors. In other examples, capacitors, inductors, and the like may be used instead.

FIG. 4 illustrates a node (represented by a dot) between circuit components 416a and 416b and an output. The voltage level at the output is based on the combination of circuit components 416a and 416b, as may be represented in Expression 1:

$${V}_{o} = \frac{{Z}_{2}}{{Z}_{1} + {Z}_{2}} \times {V}_{S} \qquad Expression 1$$

Referring to FIG. 4, Vₒ refers to the voltage at the output of level shifter 406; Z₂ refers to the impedance exhibited by circuit component 416b, which is the circuit component between the node and a ground; and Z₁ refers to the impedance exhibited by circuit component 416a, which is the circuit component between the input and the node. It is noted that impedance for capacitors is inversely proportional to the capacitance value, as shall be shown hereinafter. As should be apparent, the shifted voltage level will be based on a ratio of circuit components selected for 416a and 416b. For instance, a ratio of Vₒ to Vₛ of approximately ½ may be achieved by the selection of Z₁ and Z₂ to yield approximately ½.

As should be appreciated, different characteristics of level shifter 406 can be altered based on the selection of circuit components 416a and 416b and/or the ratio of Z₂ to Z₁. By way of example, capacitors may be selected for use cases in which Vₛ is an AC input. Inductors may be selected for both AC and DC use cases, however, for the DC use case the Vₒ will be based on the resistance associated with the inductors. And by way of further example, resistors may be selected (along with respective resistance values) based on desired output voltage, current levels, and power to be consumed, among other things.

With each of the possible circuit components, Expression 1 varies as shown by the following label changes.

$${V}_{o} = \frac{{R}_{2}}{{R}_{1} + {R}_{2}} \times {V}_{S} \qquad Expression 2$$

$${V}_{o} = \frac{{L}_{2}}{{L}_{1} + {L}_{2}} \times {V}_{S} \qquad Expression 3$$

$${V}_{o} = \frac{{C}_{1}}{{C}_{1} + {C}_{2}} \times {V}_{S} \qquad Expression 4$$

Expression 2 describes the relationship between components for the case of a voltage divider with resistors. As noted above, it also describes the relationship between resistivity values of inductors for a DC current input use case. Expression 3 describes the relationship between inductance of inductors for an AC input use case. And Expression 4 represents the relationship between capacitance of capacitors based on an AC input current. The following figures demonstrate a number of possible implementations for a voltage divider-based level shifter 406. FIGS. 5A-5E, described hereinafter, illustrate a number of possible implementations of voltage dividers using different circuit components. This is done without limitation. Additionally, it is noted that the present disclosure contemplates other (non-voltage divider) implementations, such as the use of a voltage regulator, by way of non-limiting illustration.

With the foregoing in mind, in one example of an input voltage agnostic fluidic device (e.g., fluidic device 100 of FIG. 1), the level shifter (e.g., level shifter 106 of FIG. 1) may be a voltage divider (e.g., the voltage divider implementation of level shifter 406 in FIG. 4) configured to receive control signals and shift the voltage of the control signals from an original level to a second voltage level. In this example, the second voltage level may be at least 2V lower than the original voltage level. Additionally, the ratio of the second voltage level to the first voltage level may be less than one, such as ¼ to ½, by way of non-limiting illustration.

In one example, the voltage divider of the input voltage agnostic fluidic device may have two circuit components (e.g., circuit components 416a and 416b) connected in series between the input electrical interconnect component (e.g., interconnect 104 of FIG. 1) and ground, and an output of the voltage divider connected to a node between the two circuit components.

Turning now to FIGS. 5A-5C, several example voltage dividers are illustrated. These examples are not to be taken in a limiting sense. First, FIG. 5A illustrate a resistor-based voltage divider comprising resistors R1 and R2 for circuit components 516a and 516b, respectively. As noted, resistors R1 and R2 are arranged in series between an input (e.g., from an interconnect, such as interconnect 104 of FIG. 1) and a ground. An output of the voltage divider may be connected to a node between resistors R1 and R2. And Vₒ may be based on the resistivity of resistors R1 and R2, consistent with Expression 2, above. For instance, to shift a Vs of 12V to 5V, R1 and R2 may be selected to be 7 kΩ and 5 kΩ, respectively.

One consideration in the selection of resistors R1 and R2 is power consumption. For instance, there may be a desire to select resistors R1 and R2 as being large to avoid power waste. But resistor size may have an impact on the speed of the voltage divider. For instance, in an implementation with large resistors, capacitive loads will be driven relatively slowly. With these features in mind, a voltage divider may be constructed to meet design constraints and objectives.

Turning to FIG. 5B, a voltage divider implementation is illustrated using a diode (e.g., diode D1 used for circuit component 516b, where diode D1 could be a Zener, silicon, or Schottky, by way of non-limiting example). In this example, diode D1 replaces R2 in the implementation of FIG. 5A. The output voltage of level shifter 506 will depend on the breakdown voltage of D1. In this case, Vₒ will swing between 0V and the breakdown voltage of diode D1 independent of Vₛ (at least in the ideal sense). This relationship may be expressed as Vₒ=lowestof(Vₛ, V_{z}), where V_{z} refers to the breakdown voltage of the diode. In some cases, a large R1 may be selected, similar to the implementation of FIG. 5A, to avoid power waste.

While the implementation of FIG. 5B may operate more quickly than the implementation of FIG. 5A, variations in breakdown voltage of diode D1 (e.g., due to process variation) can lead to a loss of accuracy and/or predictability of the output voltage. Such tradeoffs may influence design of level shifter 506.

Next, FIG. 5C illustrates yet another voltage divider implementation. In this case, in addition to circuit components 516a and 516b, circuit components 516c and 516d may be used. The addition of a transistor M1 (as circuit component 516c) may be of interest, such as to provide a buffer between the output of the voltage divider and the voltage divider portion of level shifter 506. Consequently, the effect of capacitive loads is applied to transistor M1 rather than resistors R1 and R2. This can offer improved speed to the circuit. Diode D1 between the source and drain of transistor M1 may be useful to facilitate discharge of Vₒ when Vₛ goes low. The output voltage of level shifter 506 will depend on the threshold voltage, or V_{gs(th)}, of the transistor in addition to the impedance values of resistors R1 and R2. Thus, Vₒ may be expressed as:

$${V}_{o} = \frac{{Z}_{2}}{{Z}_{1} + {Z}_{2}} - {V}_{gs ( th )} .$$

In view of the foregoing, one example level shifter (e.g., level shifter 506) of an input voltage agnostic fluidic device may include at least one resistor, such as is shown in the examples of FIGS. 5A, 5B, and 5C. In one example level shifter, at least one diode may be included, such as illustrated by the examples of FIGS. 5B and 5C. And in another example level shifter, a transistor (e.g., transistor M1) may be included in addition to the two circuit components (e.g., R1 and R2), as illustrated by the example of FIG. 5C.

As noted above, there is a desire for flexibility in use of fluidic devices. And while the examples of FIGS. 5A-5C provide additional flexibility, the particular level shifter arrangements may need to be customized to a particular use case. For instance, level shifter 506 may be designed to shift an input voltage level from 12V down to 3.3V. But as a result, the fluidic device (e.g., fluidic device 100 in FIG. 1) would not be usable in a system with control signals having voltage levels of 16V or 5V, by way of example. There may be a desire, therefore, for additional flexibility that would allow fluidic devices to be used in a greater range of potential systems.

FIGS. 5D and 5E illustrate level shifters 506 that are configurable. As used herein, the term “configurable” refers to the ability to alter a voltage shifter arrangement based on use cases. As such, a level shifter, such as level shifter 506 in FIG. 5D may be usable in systems with control signals of either 12V or 16V. The configuration of level shifter 506 for a particular system may be made at fabrication (e.g., if a batch of fluidic devices are being fabricated to go into a 12V system, then level shifter 506 may be configured in a first arrangement, if 16V, then a second arrangement, etc.). Alternatively, level shifter 506 may be programmably configurable. For instance, fluidic devices may be designed with the ability to detect a voltage level of control signals (e.g., such as with the assistance of a controller, like controller 272 in FIG. 2A), and may cause level shifter to be configured to a particular arrangement based on the detected voltage levels.

As should be appreciated, it may be desirable to have a fluidic device having supporting circuitry to enable use in a number of different systems (e.g., having different operating characteristics and parameters).

Turning to FIG. 5D, it will be appreciated that the output voltage, Vₒ, will be defined consistent with Expression 2, where R1 in Expression 2 is going to be the resistor (R1, R2, or the parallel combination thereof, corresponding to circuit components 516a or 516b, respectively) with the closed switch, and R2 in Expression 2 will correspond to R3 (circuit component 516c).

Level shifter 516 in FIG. 5E is similar to the implementation of FIG. 5C, and thus, the output voltage, Vₒ, will be similar to the expression described above in relation to FIG. 5C.

In view of the foregoing, therefore, one example voltage divider (e.g., level shifter 506) of an input voltage agnostic fluidic device (e.g., fluidic device 100 of FIG. 1) may be a configurable voltage divider (e.g., level shifter 506 of FIG. 5D or level shifter 506 of FIG. 5E). And further, in other example cases, the configurable voltage divider may be programmably configurable. Instead, though, a switch of the two switches between the input electrical interconnect and the output voltage node may be closed at fabrication. Thus, for instance, one switch of the pair of switches may be formed in a closed position, while the other switch of the pair of switches may be formed in an open position.

Thus, in some cases, the voltage divider may include a pair of circuit components (e.g., circuit components 516a and 516b of FIG. 5D) arranged in parallel between the input electrical interconnect and a voltage output node, an additional circuit component (e.g., circuit component 516c of FIG. 5D) connected between the voltage output node and ground. A corresponding switch is then arranged between each circuit component of the pair of circuit components and the input electrical interconnect, as shown in FIGS. 5D and 5E.

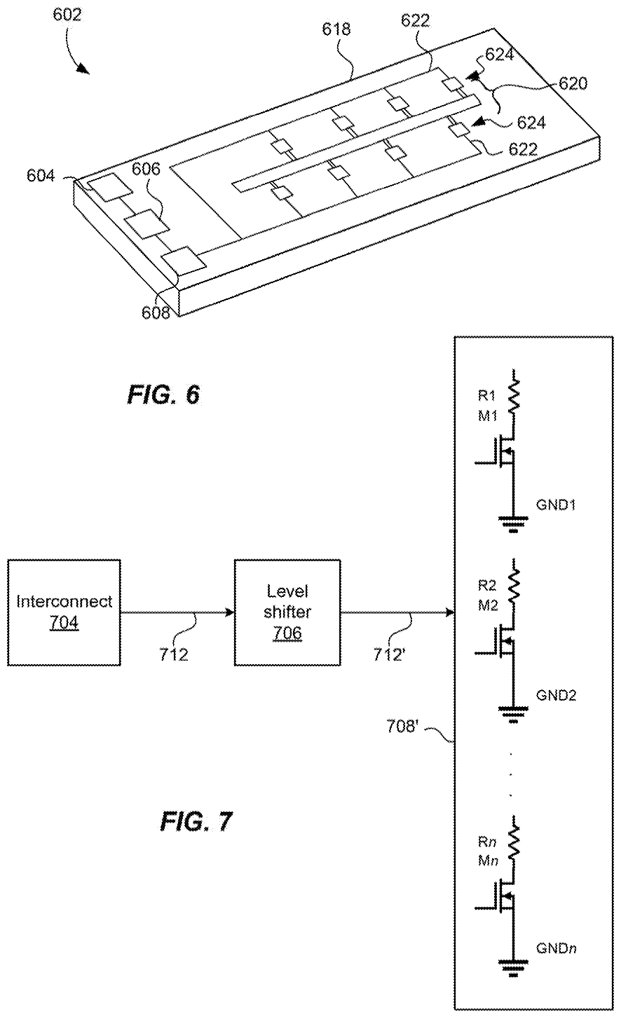

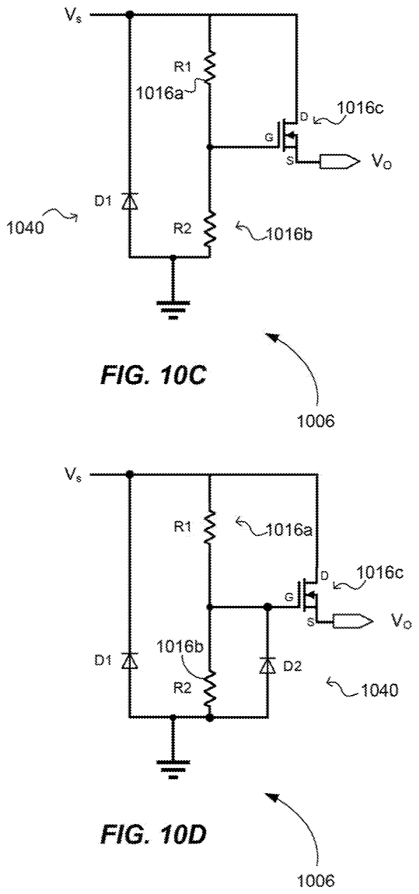

FIG. 6 illustrates an example fluidic die 602, similar to those described previously (e.g., fluidic die 102 in FIG. 1). Fluidic die 602 may be similar in structure and/or operation to those described previously. For instance, fluidic die 602 comprises an interconnect 604, a level shifter 606, and on-chip devices 608. It is noted that the blocks representing interconnect 604, level shifter 606, and on-chip devices 608 are schematic in nature, and elements thereof may be mixed in fabricated dies. Thus, for example, the wire traces (e.g., electrical communication paths 622) illustrated between on-chip devices 608 and fluid ejection chambers 624 are intended to illustrate a logical connection via which signals may be exchanged, such as control signals for causing fluid ejection chambers 624 to eject printing fluids. FIG. 6 also includes an illustration of fluid passages 620, which allow printing fluid to enter fluidic die 602 and be distributed to fluid ejection chambers 624, Fluidic die 602 is illustrated as being built on a substrate 618, such as made of a semiconductor material (e.g., silicon). The formation on substrate 618 may be as part of a build up process (e.g., photolithography) or machining as is described hereinafter in reference to FIG. 9.

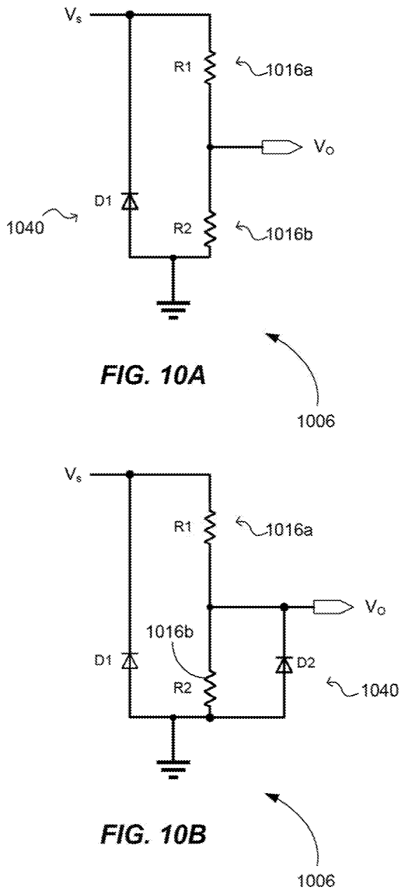

The following description of operation of a fluidic device (e.g., fluidic device 100 in FIG. 1) and fluidic die 602 will include reference to example method 800 of FIG. 8. In operation, control signals may be used to cause desired fluid ejection chambers 624 to eject printing fluids. The control signals may be used for addressing (e.g., indicating which ejection chamber of the fluid ejection chambers 624 to activate) and also to actuate fluidic ejection actuators (e.g., thermal inkjet (TIJ) resistors or piezoelectric inkjet (PIJ) actuators). A number of on-chip devices (such as those illustrated schematically by on-chip devices 608) may be used to enable selection of a particular fluid ejection chamber and to pass on control signals to the desired fluid ejection actuator. As described previously, the on-chip devices may have operational parameters or thresholds associated with a particular fabrication process used in fabrication thereof. And in some cases, those operational parameters or thresholds may be inconsistent with the control signal levels of the system in which fluidic die 602 may be used. For instance, fluidic die 602 may have been fabricated using a 1 μm process, while the system in which fluidic die 602 is to be used may have been designed with operational parameters consistent with a 4 μm fabrication process.

Thus, level shifter 606 may be used to shift the voltage levels of the control signals received at interconnect 604 to levels that are consistent with the operational parameters and thresholds of on-chip devices 608. As described, therefore, control signals may be transmitted to interconnect 604. The control signals may have a voltage level of at a first level (e.g., 12V). As shown at block 805 of method 800 in FIG. 8, then, control signals may be received of a first voltage level. The control signals may be passed from interconnect 604 to level shifter 606 to shift the voltage level of the control signals to a second level (e.g., 5.5V). As shown at block 810 in FIG. 8, the received control signals may be adjusted to a second voltage level. As noted above, in a case in which the level shifter (e.g., 506, 606, 706, 1006) is programmably configurable, signals may be received at level shifter to configure the level shifter to a desired configuration. The signals may be received from a component of the fluidic device (e.g., fluidic device 100 of FIG. 1) or externally, such as from a controller of the system. The voltage shifted control signals may then be passed on to on-chip devices (e.g., 108, 608, 708) to enable operation of a fluidic die (e.g., 102, 602).

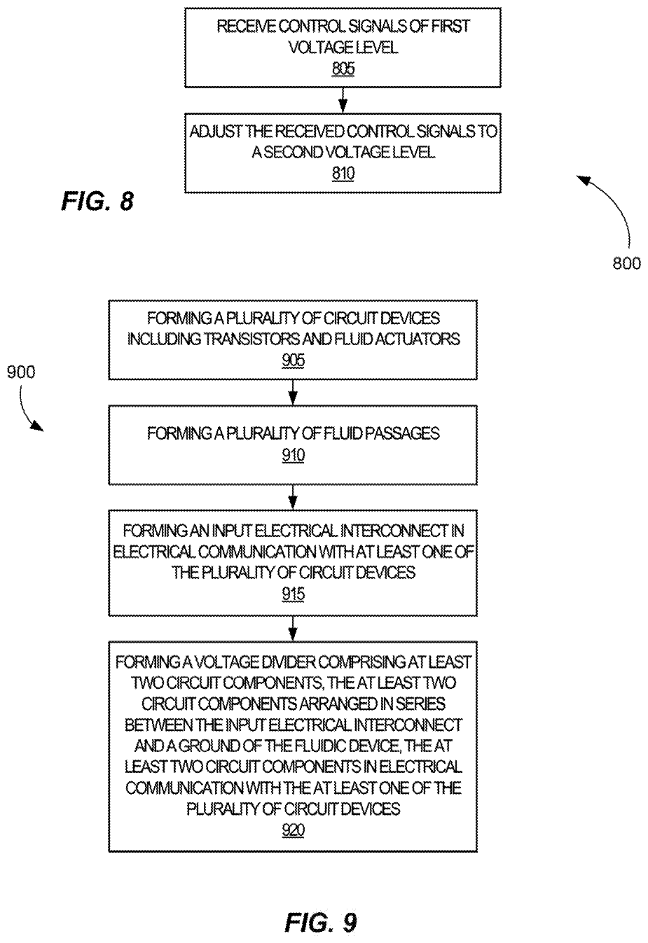

FIG. 7 focuses on one implementation of on-chip devices (e.g., on-chip devices 608 of FIG. 6). FIG. 7 uses a slightly modified schematic block to represent on-chip devices 708′. On-chip devices 708′ may be similar to on-chip devices 608 of FIG. 6 in structure and/or operation. Additionally, on-chip devices 708′ include a number of circuit components that may correspond to the ejection chambers (e.g., fluid ejection chambers 624 of FIG. 6) and/or fluid actuator addressing. For instance, an array of transistors and resistors are used to illustrate a TIJ implementation. Based on control signals, one or more of transistors M1, M2, and Mn may be activated. And based on the voltage applied to the gate of the transistors, current may or may not be allowed to flow through corresponding resistors R1, R2, or Rn, respectively (also referred to in a more general sense as fluidic actuators, such as to encompass other forms of fluidic actuators, such as piezoelectric actuators).

With this in mind, and consistent with the explanation of fluidic die 602, control signals may be received at interconnect 704 and passed to level shifter 706, such as illustrated by arrow 712. The control signals may be shifted, as described above, resulting in voltage shifted control signals, as illustrated by arrow 712′. While the circuit components of on-chip devices 708′ may have operational parameters and thresholds inconsistent with the voltage level of the control signals represented by arrow 712, the voltage level of the control signals represented by arrow 712′ may be within those operational parameters and thresholds.

In yet another example, then, a fluid ejection device (e.g., fluidic device 100) may include a fluidic die (e.g., fluidic die 102) and a configurable voltage shifter (e.g., level shifter 106). The fluidic die may include a plurality of fluidic actuators (e.g., R1, R2, and Rn in FIG. 7) in electrical communication with a plurality of transistors (e.g., M1, M2, and Mn) to enable actuation of the fluidic actuators. The plurality of transistors has an operational voltage threshold corresponding to a first level (e.g., due to a fabrication process). The configurable voltage shifter on the fluidic die may include a combination of circuit elements (e.g., level shifter 506 of FIGS. 5A-5E) arranged between an input electrical interconnect (e.g., interconnect 704) and at least one of the plurality of transistors. The configurable voltage shifter is to receive control signals corresponding to a second voltage level from the input electrical interconnect and adjust the to-be-received control signals from the second voltage level to the first voltage level.

FIG. 9 illustrates an example method 900 of fabricating a fluidic device (e.g., fluidic device 100 in FIG. 1). As illustrated at block 905, a plurality of circuit devices (e.g., on-chip devices 708′), including transistors and fluid actuators, may be formed on a substrate (e.g., substrate 618 in FIG. 6). As illustrated at block 910, a plurality of fluid passages (e.g., fluid passages 620 in FIG. 6) may be formed on the substrate. The transistors and fluidic actuators formed at block 905 may be used to enable fluid flow through the plurality of fluid passages. At block 915, an input electrical interconnect (e.g., interconnect 104 in FIG. 1) may be formed on the substrate in electrical communication with at least one of the plurality of circuit devices. As shown at block 920, a voltage divider (e.g., level shifter 406 in FIG. 4) comprising at least two circuit components (e.g., circuit component 416a and 416b in FIG. 4) may also be formed on the substrate. The at least two circuit components are to be arranged in series between the input electrical interconnect and a ground of the fluidic device. The at least two circuit components are also to be in electrical communication with the at least one of the plurality of circuit devices via a node between the at least two circuit components. And the at least two circuit components are to be selected to shift control signals to be introduced via the input electrical interconnect from a second voltage level to the first voltage level.

As described previously, a voltage lever shifter such as a voltage divider may be included in a fluidic device to shift an input voltage to a level that is within operational thresholds of on-chip devices. These on-chip devices may include, for example, metal-oxide semiconductor field-effect transistors (“MOSFET”), laterally-diffused metal-oxide semiconductor (“LDMOS”) transistors, bipolar junction transistors (“BJT”), etc. Although a level shifter is capable of a moderate voltage shift that likely would occur during normal operation, it can also tolerate and shift much higher input voltages occurring outside of normal operation, such as hundreds or thousands of volts that might be involved in an electrostatic discharge (“ESD”) event. A high voltage input clamp can be deployed at the level shifter's input to protect the level shifter from these types of high voltage ESD events. However, the high-voltage input clamp, by its very nature, may also tolerate these high input voltages. Consequently, when a transistor such as a MOSFET or LDMOS is deployed downstream of the level shifter, these high voltages may represent a threat to that transistor and/or to other downstream components, such as the aforementioned on-chip devices 108, 608, 708.

Accordingly, additional examples are described herein for clamping voltages downstream of the level shifters described herein in order to protect various downstream components, such as transistors forming part of the level shifters themselves and/or other vulnerable downstream components, such as on-chip MOSFETs, LDMOSs, etc. A component that limits a voltage, referred to herein as a “clamp,” may be deployed at various locations vis-à-vis the level shifter to ensure that voltage downstream of the level shifter remains within operational thresholds. Clamps may take various forms, such as diode(s), Zener diode(s), diode-tied transistors(s), sequences of diodes, and any other device that limits a voltage.

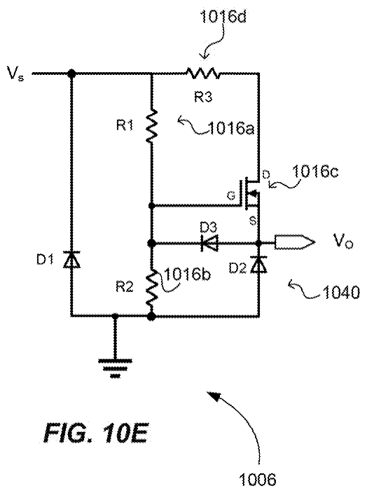

Referring now to FIG. 10A, a level shifter 1006 that share various characteristics with other level shifters described herein is depicted. Level shifter 1006 is similar to level shifter 506 of FIG. 10A in that it shifts an input voltage (Vₛ) to an output voltage (Vₒ). However, level shifter 1006 also includes a clamp circuit 1040 to clamp a voltage associated with (e.g., downstream from) level shifter 1006 to below an operational threshold of components (not depicted) downstream of level shifter 1006, such as on-chip device(s) 108, 608, 708.

In this example, clamp circuit 1040 includes a diode D1 that is coupled in parallel with circuit components 1016a and 1016b, which in FIG. 10A take the form of resistors R1 and R2, respectively. Diode D1 may begin conducting at some threshold voltage to clamp the output voltage (Vₒ) to below operational thresholds of on-chip device(s) 108 downstream. For example, diode D1 may begin conducting at, say, 40V, at which point it will draw excess current to ground. It should be understood that the clamp circuit 1040 of FIG. 10A, as well as other clamp circuits depicted in FIGS. 10B-E, can also be employed with other arrangements of circuit components 1016a and 1016b, such as where circuit component 1016b is a diode instead of a resistor, as depicted in FIG. 5B.

FIG. 10B depicts an alternative example of a level shifter 1006 configured with selected aspects of the present disclosure. In FIG. 10B, a clamp circuit 1040 is once again provided, and once again includes a first diode D1 coupled in parallel with circuit components 1016a and 1016b. However, unlike in FIG. 10A, in FIG. 10B, clamp circuit 1040 includes an additional diode D2 coupled in parallel with circuit component 1016b. This additional diode D2 may provide additional protection over that provided by the diode D1. For example, D1 may begin conducting at 40V, whereas diode D2 may begin conducting (and dissipating charge to ground) at a lower voltage than D1, say, at 7V.

FIG. 10C depicts an alternative example in which level shifter 1006 includes, in addition to circuit components 1016a and 1016b, a circuit component 1016c in the form of a transistor, such as a MOSFET or LDMOS. As depicted, circuit component 1016c includes a gate pin G, a source pin S, and a drain pin D. Similar to FIG. 10A, in FIG. 10C, a clamp circuit 1040 includes a single diode D1 coupled in parallel to circuit components 1016a and 1016b. With the configuration of clamp circuit 1040 in FIG. 10C, although circuit component 1016c is protected, a high voltage event such as an ESD may nonetheless cause the output voltage (Vₒ) to be greater than operational thresholds of downstream components, such as on-chip devices 108.

This issue is addressed in the examples depicted in FIGS. 10D and 10E. In FIG. 10D, level shifter 1006 once again includes circuit components 1016a (R1), 1016b (R2), and 1016c (e.g., MOSFET, LDMOS). However, in addition to diode D1, clamp circuit 1040 in FIG. 10D also includes another diode D2 coupled in parallel with circuit component 1016b, similar to FIG. 10B. Diode D2 clamps a gate voltage of circuit component 1016c to at and/or below operational thresholds of downstream component(s) such as on-chip device(s) 108, 608, 708. In FIG. 10D, diode D2 is coupled in series with a gate pin of circuit component 1016c; however, other arrangements are contemplated. With the arrangement of FIG. 10D, source-follower operation ensures that voltage (Vₒ) downstream of circuit component 1016c remains within the operational threshold.

FIG. 10E depicts another level shifter 1006 that, like the level shifter 1006 of FIG. 10D, includes circuit components 1016a (R1), 1016b (R2), and 1016c (e.g., MOSFET, LDMOS). However, level shifter 1006 in FIG. 10E also includes another circuit component 1016d, which takes the form of a resistor R3 in the example of FIG. 10E. Resistor R3 is coupled in series with a drain pin D of circuit component 1016c, but this is not meant to be limiting. Resistor R3 reduces/limits the current through circuit component 1016c and a second diode D2 that will be discussed shortly.

In FIG. 10E, clamp circuit 1040 includes a first diode D1 that is coupled in parallel to circuit components 1016a and 1016b, similar to previous examples. Clamp circuit 1040 also includes a second diode D2 and a third diode D3. In FIG. 10E, second diode D2 is coupled in series with the source pin S of circuit component 1016c, in between the source pin S and downstream components, such as on-chip device(s) 108. Third diode D3 is coupled in parallel with the gate pin G of the circuit component 1016c, With the arrangement of FIG. 10E, the voltage (Vₒ) downstream of circuit component 1016c is directly clamped to at or below operational threshold(s) of downstream component(s), such as various on-chip devices 108.

In the examples of FIGS. 10A-E, the level shifter 1006 was static. However, this is not meant to be limiting. The clamp circuits 1040 employed with these static level shifters may also be employed with configurable level shifters, such as level shifters 506 depicted in FIGS. 5D and 5E.

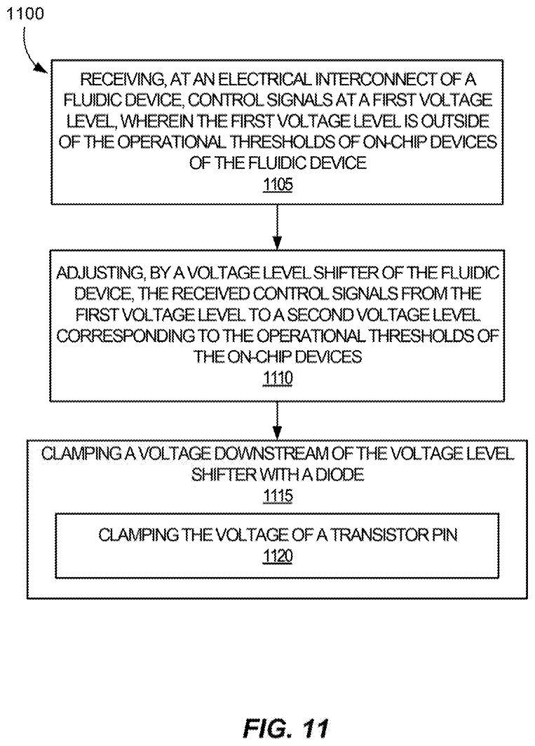

FIG. 11 depicts an example method 1100 for practicing selected aspects of the present disclosure, in accordance with various examples. At block 1105, which may be similar to block 805 of method 800 in FIG. 8, control signal(s) are received at an electrical interconnect, such as electrical interconnects 104, 604, 704, electrical interconnect 604 in FIG. 6, or electrical interconnect 704 of FIG. 7. These control signal(s) may be at a first voltage level that may be outside of operational thresholds of various downstream components, such as on-chip devices 108, 608, 708.

At block 1110, similar to block 810 of method 800 of FIG. 8, the control signal(s) received at block 1105 may be adjusted, e.g., by a level shifter such as 106, 506, 1006 described herein, from the first voltage level to a second voltage level corresponding to (e.g., within) the operational threshold(s) of components downstream from the level shifter, such as on chip device(s) 108. As noted above, in a case in which level shifter 606 is programmably configurable, signals may be received at level shifter 606 to configure level shifter 606 to a desired configuration. The signals may be received from a component of the fluidic device (e.g., fluidic device 100 of FIG. 1) or externally, such as from a controller of the system.

The operations of blocks 1115 and 1120 may occur simultaneously and/or contemporaneously with the operations of block 1115. At block 1115, a voltage downstream of the level shifter may be clamped, e.g., with a diode such as D2 and/or D3 depicted in FIG. 10B, 10D, or 10E. In some examples, such as those depicted in FIGS. 10D and 10E, this clamping may include clamping the voltage of a transistor pin, such as the gate pin G, source pin 5, and/or drain pin D of circuit component 1016c in FIG. 10D or 10E.

For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

The preceding description and following claims also use terms such as “at least,” “one or more,” and “and/or” in an abundance of caution. Nevertheless, the use thereof is not intended to suggest that instances in which these terms were not used are to be restricted to closed-ended cases. Thus, for example, reference to “one” or “a” fluidic device is intended to open-endedly include both cases in which only one fluidic device is used and also cases in which more than one fluidic device is used.

What is claimed is:

1. An input voltage agnostic fluidic device comprising:
an input electrical interconnect component to receive a control signal from outside of the input voltage agnostic fluidic device;
a fluidic die comprising an on-chip device downstream of the input electrical interconnect component;
a voltage divider to receive the control signal via the input electrical interconnect component and shift a voltage of the control signal to a voltage level that is within an operational threshold of the on-chip device; and
a clamp circuit to clamp circuitry downstream of the voltage divider below the operational threshold of the on-chip device.

2. The input voltage agnostic fluidic device of claim 1, wherein the clamp circuit comprises a diode coupled in parallel to one resistor of the voltage divider.

3. The input voltage agnostic fluidic device of claim 1, wherein the clamp circuit clamps a gate voltage of a transistor downstream of the voltage divider.

4. The input voltage agnostic fluidic device of claim 3, wherein the clamp circuit comprises a diode coupled in series with a gate pin or source pin of the transistor.

5. The input voltage agnostic fluidic device of claim 4, wherein the clamp circuit comprises another diode coupled in parallel with a gate pin of the transistor.

6. The input voltage agnostic fluidic device of claim 3, wherein the clamp circuit comprises a diode coupled between a source pin of the transistor and the on-chip device.

7. The input voltage agnostic fluidic device of claim 3, wherein the transistor comprises a metal-oxide semiconductor field-effect transistor (“MOSFET”).

8. The input voltage agnostic fluidic device of claim 7, wherein the MOSFET comprises a laterally-diffused metal-oxide semiconductor (“LDMOS”).

9. An input voltage agnostic fluidic device comprising:
a fluidic die comprising on-chip devices having operational parameters corresponding to a first voltage range;
a level shifter connected to an input electrical interconnect of the fluidic device, the input electrical interconnect to receive control signals in a second voltage range, wherein the first voltage range is less than the second voltage range, and further wherein the level shifter is to shift an input voltage of the control signals from the second voltage range to the first voltage range;
a transistor between the level shifter and the input electrical interconnect; and
a clamp to clamp a voltage associated with the transistor to within the first voltage range.

10. The input voltage agnostic fluidic device of claim 9, wherein a gate pin of the transistor is coupled to an output of the level shifter.

11. The input voltage agnostic fluidic device of claim 10, wherein the clamp comprises a diode coupled in series to the gate pin.

12. The input voltage agnostic fluidic device of claim 10, wherein the clamp comprises a first diode coupled in parallel to the gate pin and a second diode coupled in series of a source pin of the transistor.

13. A method of operating a fluidic device, the method comprising:
receiving, at an electrical interconnect of the fluidic device, control signals at a first voltage level, wherein the first voltage level is outside of an operational threshold of on-chip devices of the fluidic device;
adjusting, by a voltage level shifter of the fluidic device, the received control signals from the first voltage level to a second voltage level corresponding to the operational threshold of the on-chip devices; and
clamping a voltage downstream of the voltage level shifter with a diode.

14. The method of claim 13, wherein the clamping includes clamping the voltage of a transistor pin downstream of the voltage level shifter.

15. The method of claim 14, wherein transistor pin comprises a gate pin or a source pin.
